(19) United States
(12) Patent Application Publication
(10) Pub. No.: US 2016/0064973 A1
(43) Pub. Date: Mar. 3, 2016

(54) BATTERY PROTECTION CIRCUIT PACKAGE

(71) Applicant: ITM SEMICONDUCTOR CO., LTD., Chungcheongbuk-do (KR)

(72) Inventors: Hyeok Hwi NA, Chungcheongbuk-do (KR); Ho Seok HWANG, Gyeonggi-do (KR); Young Seok KIM, Chungcheongbuk-do (KR); Sung Beom PARK, Gyeonggi-do (KR); Sang Hoon AHN, Chungcheongbuk-do (KR); Sun Ho KIM, Gyeonggi-do (KR)

(21) Appl. No.: 14/814,905

(22) Filed: Jul. 31, 2015

(30) Foreign Application Priority Data
Aug. 27, 2014 (KR) 10-2014-0112405

(51) Int. Cl. H02J 7/00

(52) U.S. Cl. CPC H02J 7/0029; H02J 7/0083; H02J 7/0078; H02J 2007/004; H02J 2007/0037

(57) ABSTRACT

Disclosed is a battery protection circuit package capable of ensuring stability of a battery, the package including a substrate having a plurality of external connection terminals and a plurality of internal connection terminals, and a protection integrated chip (IC), one or more field effect transistors (FETs), and one or more passive devices provided on the substrate, wherein the protection IC includes a separate IC structure capable of forcibly blocking discharge or charge of the battery bare cell by switching off the FETs when an electrical signal is input through one of the external connection terminals.

### CROSS-REFERENCE TO RELATED PATENT APPLICATION

This application claims the benefit of Korean Patent Application No. 10-2014-0112405, filed on Aug. 27, 2014, in the Korean Intellectual Property Office, the disclosure of which is incorporated herein in its entirety by reference.

### BACKGROUND

1. Field

The present invention relates to a battery protection circuit package and, more particularly, to a battery protection circuit package capable of ensuring stability of a battery.

2. Description of the Related Art

A battery is generally used in portable devices such as a mobile phone and a personal digital assistant (PDA). As the most commonly used battery in the portable devices, a lithium ion battery even has the risk of explosion as well as performance degradation when overcharge, overdischarge, and/or overcurrent occur. Accordingly, an apparatus for detecting and blocking overcharge, overdischarge, and/or overcurrent of a battery is increasingly demanded.

### RELATED ART

1. KR 10-2014-0032596 (Mar. 17, 2014)

### SUMMARY

The present invention provides a battery protection circuit package capable of ensuing stability of a battery. However, the scope of the present invention is not limited thereto.

According to an aspect of the present invention, there is provided a battery protection circuit package capable of being electrically connected to a battery bare cell, the package including a substrate having a plurality of external connection terminals and a plurality of internal connection terminals, and a protection integrated chip (IC), one or more field effect transistors (FETs), and one or more passive devices provided on the substrate, wherein the protection IC includes a separate IC structure capable of forcibly blocking discharge or charge of the battery bare cell by switching off the FETs when an electrical signal is input through one of the external connection terminals.

The FETs may include a pair of FETs having a common drain and configured as a first FET and a second FET, and the protection IC may include a terminal (VDD) for applying charge and discharge voltages and detecting a battery voltage, a reference terminal (VSS) for providing a reference voltage of an internal operation voltage, a detection terminal (V−) for detecting charge/discharge and overcurrent states, a discharge off signal output terminal (DOUT) for switching off the first FET in overdischarge state, a charge off signal output terminal (COUT) for switching off the second FET in overcharge state, and a forcible blocking terminal (CP) configured to receive the electrical signal to forcibly block discharge or charge of the battery bare cell by switching off the FETs.

The electrical signal may include an electrical signal having a high level and a low level, and the separate IC structure may include a NOT gate.

The protection IC may be stacked on the FETs.

The protection IC may not be stacked on but may be provided adjacent to the FETs to be spaced apart therefrom.

The substrate may include a lead frame having a first internal connection terminal lead and a second internal connection terminal lead separately provided at two side edges and capable of being electrically connected to electrode terminals of the battery bare cell, external connection terminal leads provided between the first and second internal connection terminal leads to configure the external connection terminals, and a mounting lead for mounting at least a part of the protection IC, the FETs, and the passive devices. In this case, at least one selected from the group consisting of the protection IC and the FETs may not be inserted and fixed into the lead frame in a form of a semiconductor package, but may be mounted and fixed onto at least a part of a surface of the lead frame using a surface mounting technology in a form of a chip die not encapsulated with an encapsulant. In addition, at this time, the battery protection circuit package may further include an electrical connection member for electrically interconnecting any two selected from the group consisting of the protection IC, the FETs, and the leads, thereby configuring a battery protection circuit without using a printed circuit board.

The protection IC, the FETs, and the passive devices may be embedded in one sub package and then provided on the substrate.

The substrate may include a printed circuit board (PCB).

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a battery protection circuit of a battery protection circuit package according to some embodiments of the present invention;

FIG. 2 is a schematic diagram showing the configuration of a protection integrated circuit (IC) in the battery protection circuit package according to some embodiments of the present invention;

FIG. 3 is a schematic diagram showing the configuration of a lead frame of the battery protection circuit package according to an embodiment of the present invention;

FIG. 4 is a schematic diagram showing the configuration of the protection IC and field effect transistors (FETs) in the battery protection circuit package according to an embodiment of the present invention;

FIG. 5 is a schematic diagram showing the configuration of the protection IC and the FETs in the battery protection circuit package according to a modified embodiment of the present invention;

FIG. 6 shows perspective views of a battery protection circuit package according to an embodiment of the present invention;

FIG. 7 is an exploded perspective view of a battery pack including the battery protection circuit package according to an embodiment of the present invention;

FIG. 8 is a perspective view of the battery pack including the battery protection circuit package according to an embodiment of the present invention;

FIG. 9 is an exploded perspective view of a battery protection circuit package according to another embodiment of the present invention;

FIG. 10 is an exploded perspective view showing the configuration of a protection IC, FETs, and passive devices in the battery protection circuit package according to another embodiment of the present invention; and

FIGS. 11 and 12 are perspective views of the battery protection circuit package according to another embodiment of the present invention.

### DETAILED DESCRIPTION

The invention now will be described in more detail with reference to the accompanying drawings, in which embodiments of the invention are shown.

The present invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the thicknesses or sizes of layers are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing.

In embodiments of the present invention, a lead frame is an element in which lead terminals are patterned on a metal frame, and may differ in terms of structure or thickness from a printed circuit board (PCB) in which a metal wiring layer is provided on an insulating core.

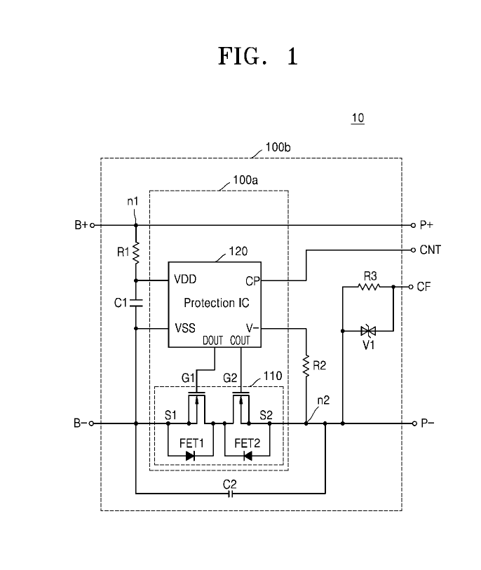

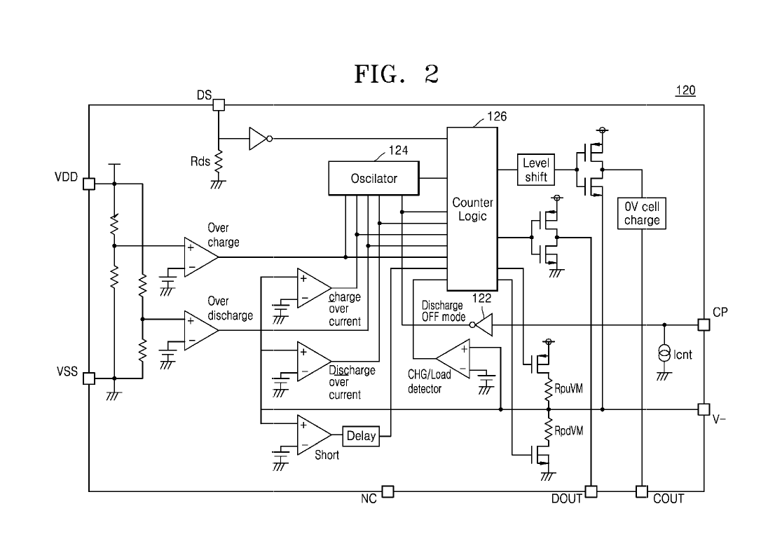

FIG. 1 is a circuit diagram of a battery protection circuit 10 of a battery protection circuit package according to some embodiments of the present invention, and FIG. 2 is a schematic diagram showing the configuration of a protection integrated circuit (IC) 120 in the battery protection circuit package according to some embodiments of the present invention.

Referring to FIGS. 1 and 2, in the battery protection circuit package according to some embodiments of the present invention, first and second internal connection terminals B+ and B− to be connected to a battery cell, and first to third external connection terminals P+, CF, and P− to be connected to a charger for charging and to be connected to an electronic device (e.g., a portable device) operating by battery power, for discharging configure a part of the battery protection circuit 10. Here, among the first to third external connection terminals P+, CF, and P−, the first and third external connection terminals P+ and P− are used to supply power and the other second external connection terminal CF is used to detect a battery type and perform charging based on the battery type. In addition, the second external connection terminal CF may be provided as a thermistor for detecting battery temperature when charging, and may be used as a terminal having another function.

Furthermore, the protection IC 120, one or more field effect transistors (FETs) 110, and one or more passive devices configure another part of the battery protection circuit 10. The passive devices may include, for example, resistors R1, R2, and R3, a varistor V1, and capacitors C1 and C2. The FETs 110 may include, for example, a pair of FETs having a common drain and configured as a first FET FET1 and a second FET FET2.

The protection IC 120 has a terminal (e.g., VDD) connected through the resistor R1 to the first internal connection terminal B+ serving as (+) terminal of the battery, applying a charge or discharge voltage through a first node n1, and detecting a battery voltage, a reference terminal (e.g., VSS) for providing a reference voltage of an internal operation voltage of the protection IC 120, a detection terminal (e.g., V−) for detecting charge/discharge and overcurrent states, a discharge off signal output terminal (e.g., DOUT) for switching off the first FET FET1 in overdischarge state, and a charge off signal output terminal (e.g., COUT) for switching off the second FET FET2 in overcharge state.

Here, the protection IC 120 includes a reference voltage setter, a comparer for comparing a reference voltage and a charge/discharge voltage to each other, an overcurrent detector, and a charge/discharge detector. Here, reference voltages for determining the charge and discharge states are variable according to specifications required by a user, and the charge and discharge states are determined based on the reference voltages by detecting the voltage difference between terminals of the protection IC 120.

The protection IC 120 is configured in such a manner that the terminal DOUT is changed to LOW state to switch off the first FET FET1 in overdischarge state, that the terminal COUT is changed to LOW state to switch off the second FET FET2 in overcharge state, and that the second FET FET2 is switched off when charging and the first FET FET1 is switched off when discharging in overcurrent state.

According to this configuration, the function for blocking discharge or charge of the battery cell controls discharge and charge depending on the voltage of the battery cell, e.g., overcharge or overdischarge.

In addition to this configuration, the present invention employs the protection IC 120 further including a forcible blocking terminal CP. The forcible blocking terminal CP may implement a forcible discharge or charge blocking function for forcibly blocking discharge or charge by switching off the FETs 110 when a specific electrical signal of a low/high level is input. A fourth external connection terminal CNT connected to the forcible blocking terminal CP may be additionally employed to input the specific electrical signal to the forcible blocking terminal CP of the protection IC 120.

The protection IC 120 includes a separate IC structure capable of forcibly blocking discharge or charge of the battery bare cell by switching off the FETs 110 when the specific electrical signal is input. The separate IC structure may be understood as a new IC called a forcible blocking IC and may include, for example, a NOT gate 122. For example, the specific electrical signal of a low/high level which is input to the forcible blocking terminal CP may pass through the NOT gate 122, an oscillator 124, and a counter logic 126 and may forcibly switch off the FETs 110 through the terminal DOUT or COUT, thereby implementing a forcible blocking function for blocking discharge or charge of the battery cell.

Meanwhile, the resister R1 and the capacitor C1 stabilize variations in power supply of the protection IC 120. The resister R1 is connected between the first node n1 serving as a power (V1) supply node of the battery, and the terminal VDD of the protection IC 120, and the capacitor C1 is connected between the terminal VDD and the terminal VSS of the protection IC 120. Here, the first node n1 is connected to the first internal connection terminal B+ and the first external connection terminal P+. If the resister R1 has a high resistance value, when a voltage is detected, the detected voltage is increased due to a current flowing into the protection IC 120. As such, the resistance value of the resister R1 is set to an appropriate value equal to or less than 1 KΩ. In addition, for stable operation, the capacitor C1 has an appropriate value equal to or greater than 0.01 μF.

The resisters R1 and R2 serve as a current limiter if a charger provides a high voltage exceeding absolute maximum ratings of the protection IC 120 or if the charger is connected with wrong polarity. The resister R2 is connected between the terminal V− of the protection IC 120 and a second node n2 connected to a source terminal S2 of the second FET FET2. Since the resisters R1 and R2 are closely related to power consumption, a sum of resistance values of the resisters R1 and R2 is set to be greater than 1 KΩ. In addition, since recovery may not occur after overcharge blocking if the resistance value of the resister R2 is excessively large, the resistance value of the resister R2 is set to a value equal to or less than 10 KΩ.

The capacitor C2 is connected between the second node n2 (or the third external connection terminal P−) and a source terminal S1 of the first FET FET1 (or the terminal VSS or the second internal connection terminal B−). The capacitor C2 does not exert a strong influence on product features of the battery protection circuit 10, but is added upon a request of the user or for stability. The capacitor C2 is used to achieve system stabilization by improving tolerance to voltage variations or external noise.

The resister R3 and the varistor V1 are devices for electrostatic discharge (ESD) and surge protection, and are connected in parallel to each other between the second external connection terminal CF and the second node n2 (or the third external connection terminal P−). The varistor V1 is a device for reducing resistance thereof when overvoltage occurs, and may minimize, for example, circuit damage due to overvoltage.

The present invention implements a battery protection circuit package by packaging a substrate including the external connection terminals P+, P−, CF, and CNT and the internal connection terminals B+ and B−, and the protection IC 120, the FETs 110, and the passive devices provided on the substrate.

The above-described battery protection circuit 10 according to some embodiments of the present invention is merely exemplary, and the numbers and locations of the FETs 110, the protection IC 120, and the passive devices are appropriately variable based on the function of the battery protection circuit 10.

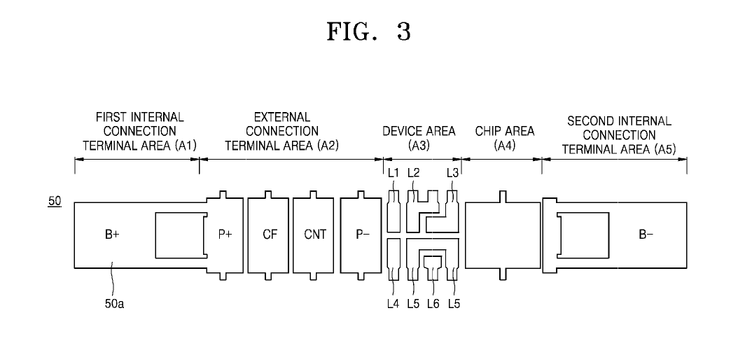

FIG. 3 is a schematic diagram showing the configuration of a lead frame 50 of the battery protection circuit package according to an embodiment of the present invention.

Referring to FIG. 3, the substrate of the battery protection circuit package according to an embodiment of the present invention may include the lead frame 50. The substrate may include only the lead frame 50.

The lead frame 50 may have, for example, a first internal connection terminal area A1, an external connection terminal area A2, a device area A3, a chip area A4, and a second internal connection terminal area A5.

The first and second internal connection terminal areas A1 and A5 are provided at two side edges of the package module, and provide thereon a first internal connection terminal lead B+ serving as a first internal connection terminal connected to a battery can accommodating the bare cell, and a second internal connection terminal lead B− serving as a second internal connection terminal, respectively. The external connection terminal area A2 provides thereon first to fourth external connection terminal leads P+, CF, P−, and CNT serving as a plurality of external connection terminals and spaced apart from each other. The order of the first to fourth external connection terminal leads P+, CF, P−, and CNT may be variously changed.

The device area A3 is an area for the passive devices R1, R2, R3, C1, C2, and V1 of the battery protection circuit 10 and may provide thereon, for example, first to sixth passive device leads L1, L2, L3, L4, L5, and L6 provided as a plurality of conductive lines spaced apart from each other. The chip area A4 is an area for the protection IC 120 and the FETs 110 of the battery protection circuit 10, and may provide thereon a plurality of leads spaced apart from each other as necessary. The leads of the device area A3 and the chip area A4 may be understood as a mounting lead for mounting at least a part of the protection IC 120, the FETs 110, and the passive devices.

The numbers and locations of the leads of the first internal connection terminal area A1, the external connection terminal area A2, the device area A3, the chip area A4, and the second internal connection terminal area A5 are depicted for illustrative purposes only, and may change appropriately based on the function of the battery protection circuit 10.

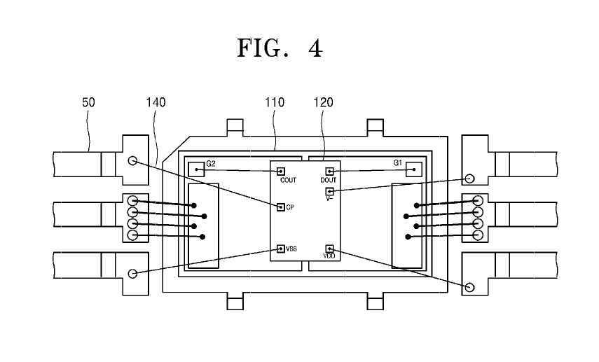

FIG. 4 is a schematic diagram showing the configuration of the protection IC 120 and the FETs 110 in the battery protection circuit package according to an embodiment of the present invention. The lead frame 50 illustrated in FIG. 4 is a modified form of the device area A3 and the chip area A4 illustrated in FIG. 3.

Referring to FIG. 4, the protection IC 120 may be stacked on the FETs 110. For example, the protection IC 120 may be stacked on a top surface of a dual FET chip 110.

The dual FET chip 110 includes two FETs, i.e., the first and second FETs FET1 and FET2 having a common drain structure, and a first gate terminal G1 and a first source terminal S1 of the first FET FET1 and a second gate terminal G2 and a second source terminal S2 of the second FET FET2 are provided as external terminals on the top surface of the dual FET chip 110. In addition, a common drain terminal may be provided on a bottom surface of the dual FET chip 110.

If the protection IC 120 is stacked on the top surface of the dual FET chip 110, the protection IC 120 is stacked on an area (e.g., a central area) of the dual FET chip 110 other than the area on which the external terminals are provided. In this case, an insulating layer for insulation may be provided between the protection IC 120 and the dual FET chip 110, and the protection IC 120 and the dual FET chip 110 may be bonded to each other using an insulating adhesive.

After the protection IC 120 is stacked on the top surface of the dual FET chip 110, the terminal DOUT of the protection IC 120 is electrically connected to the first gate terminal G1 through wire, and the terminal COUT of the protection IC 120 is electrically connected to the second gate terminal G2 through wire.

By employing the protection IC 120 and the dual FET chip 110 having the above stacked structure, a mounting area thereof on the substrate may be reduced and thus a small or high-capacity battery may be implemented.

The FETs 110 may not be inserted and fixed into the lead frame 50 in the form of a semiconductor package, but may be mounted and fixed onto at least a part of the surface of the lead frame 50 using a surface mounting technology in the form of a chip die not encapsulated with an encapsulant.

The battery protection circuit 10 may be configured without using a PCB by further including an electrical connection member 140 for electrically interconnecting any two selected from the group consisting of the protection IC 120, the FETs 110, and the leads. The electrical connection member 140 may include, for example, bonding wire or bonding ribbon.

Since the battery protection circuit 10 is configured by providing the electrical connection member 140 such as bonding wire or bonding ribbon on the lead frame 50, a process for designing and manufacturing the lead frame 50 of the battery protection circuit 10 may be simplified. According to a modified embodiment of the present invention, if the electrical connection member is not employed in the battery protection circuit 10, the configuration of the leads of the lead frame 50 may be very complicated and thus the lead frame 50 may not be appropriately and efficiently provided.

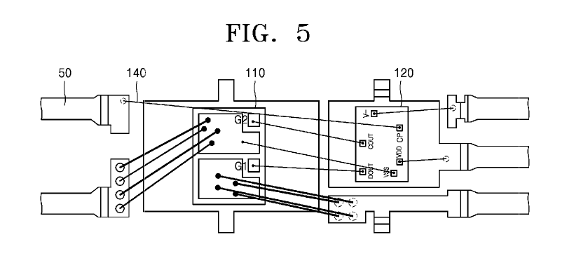

FIG. 5 is a schematic diagram showing the configuration of the protection IC 120 and the FETs 110 in the battery protection circuit package according to a modified embodiment of the present invention.

The configuration of FIG. 5 is the same as the configuration of FIG. 4 except that the protection IC 120 is not stacked on but provided adjacent to the FETs 110 to be spaced apart therefrom, and thus a repeated description therebetween is not provided here.

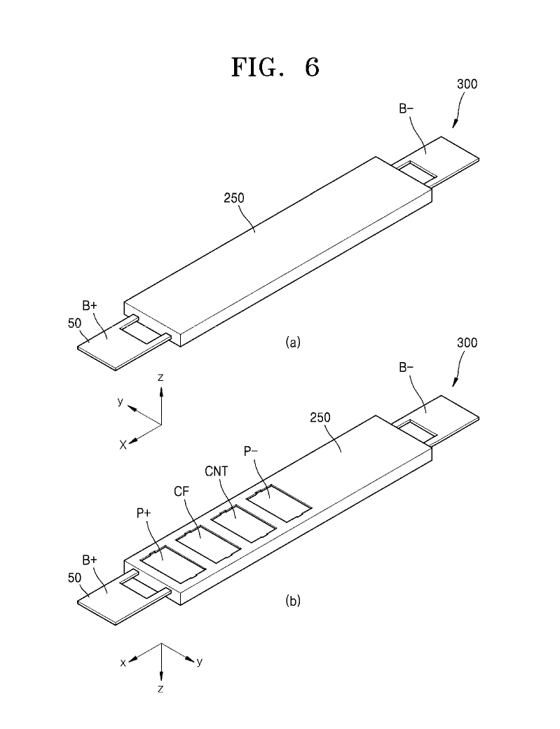

According to some embodiments of the present invention in which the substrate includes only the lead frame 50, the protection IC 120 and/or the FETs 110 may not be inserted and fixed into the lead frame 50 in the form of a semiconductor package, but may be mounted and fixed onto at least a part of the surface of the lead frame 50 using a surface mounting technology in the form of a chip die not encapsulated with an encapsulant but sawed on a wafer. Here, the chip die refers to an individual structure not encapsulated with an encapsulant but implemented by performing a sawing process on a wafer having an array of a plurality of structures (e.g., a protection IC and FETs) thereon. That is, since the protection IC 120 and/or the FETs 110 are mounted on the lead frame 50 in non-encapsulated state and then are encapsulated with an encapsulant 250 (see FIG. 6), only one encapsulation process is necessary to implement the battery protection circuit package. On the contrary, if the passive devices, the protection IC 120, and/or the FETs 110 are inserted and fixed or mounted into a PCB, each component may initially require one molding process and then additionally require another molding process after fixed or mounted on the PCB, thereby causing a complicated manufacturing process and a high manufacturing cost.

FIG. 6 shows perspective views of a battery protection circuit package 300 according to an embodiment of the present invention. Specifically, (a) of FIG. 6 shows a first surface of the battery protection circuit package 300 according to an embodiment of the present invention, and (b) of FIG. 6 shows a second surface of the battery protection circuit package 300. The second surface of the battery protection circuit package 300 may expose the external connection terminals P+, CF, CNT, and P−.

The battery protection circuit package 300 illustrated in FIG. 6 may be implemented by mounting the protection IC 120, the FETs 110, and the passive devices on the lead frame 50 of FIG. 3, and then encapsulating the same with the encapsulant 250. A part of at least one of the first and second internal connection terminal leads B+ and B− exposed without being encapsulated by the encapsulant 250 may be bent in the form of a gull.

Although not shown in FIG. 6, the passive devices may be provided to interconnect at least some of the leads of the lead frame 50 which are spaced apart from each other. In addition, by employing an electrical connection member for electrically interconnecting any two selected from the group consisting of the protection IC 120, the FETs 110, and the leads, the battery protection circuit 10 may be configured without using a PCB.

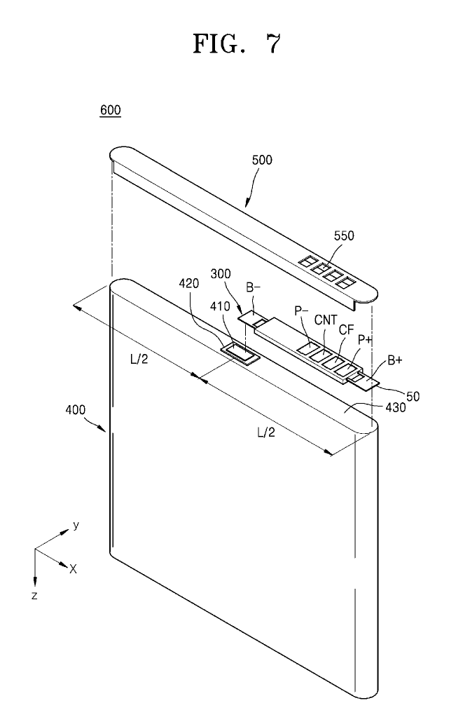

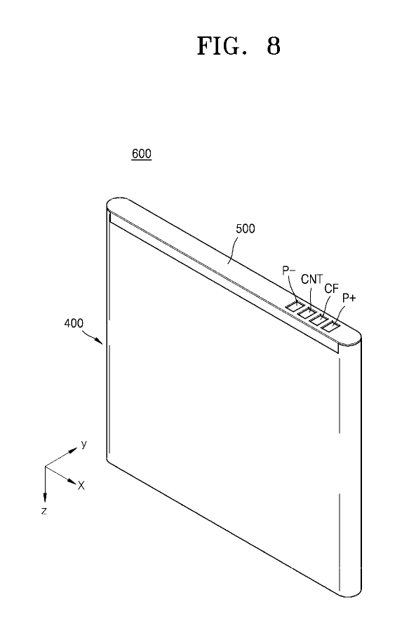

FIG. 7 is an exploded perspective view of a battery pack 600 including the battery protection circuit package 300 according to an embodiment of the present invention, and FIG. 8 is a perspective view of the battery pack 600 including the battery protection circuit package 300 according to an embodiment of the present invention.

Referring to FIGS. 7 and 8, the battery protection circuit package 300 is inserted between a lid 500 and a top surface of a battery bare cell accommodated in a battery can 400, thereby configuring the battery pack 600. The lid 500 is formed of a plastic material and has through holes 550 to expose the external connection terminals P+, CF, CNT, and P−. The battery pack 600 may be understood as a battery generally used in a mobile phone or a portable device.

The battery bear cell includes an electrode assembly and a cap assembly. The electrode assembly may include a positive plate formed by coating a positive active material on a positive current collector, a negative plate formed by coating a negative active material on a negative current collector, and a separator provided between the positive plate and the negative plate to prevent a short circuit therebetween and allow lithium ions to move. A positive tap adhered to the positive plate and a negative tap adhered to the negative plate protrude from the electrode assembly.

The cap assembly includes a negative terminal 410, a gasket 420, and a cap plate 430. The cap plate 430 may serve as a positive terminal. The negative terminal 410 may also be called a negative cell or an electrode cell. The gasket 420 may be formed of an insulating material to insulate the negative terminal 410 and the cap plate 430 from each other. Accordingly, electrode terminals of the battery bear cell may include the negative terminal 410 and the cap plate 430. A part of the lead frame 50 of the battery protection circuit package 300 according to an embodiment of the present invention may be directly bonded to the electrode terminals 410 and 430 of the battery bare cell. The lead frame 50 may be formed using nickel (Ni) or a copper (Cu) plate plated with Ni, and the first and second internal connection terminal leads B+ and B− of the lead frame 50 may be bonded to the electrode terminals 410 and 430 of the battery bare cell using, for example, laser welding, resistance welding, or conductive epoxy.

The electrode terminals of the battery bare cell includes a plate 430 having a first polarity (e.g., positive polarity) and an electrode cell 410 having a second polarity (e.g., negative polarity) and provided at the center of the plate 430, and the first internal connection terminal lead B+may be directly bonded and electrically connected to the plate 430 having the first polarity (e.g., positive polarity) while the second internal connection terminal lead B− may be directly bonded and electrically connected to the electrode cell 410 having the second polarity (e.g., negative polarity). In this case, the length of the battery protection circuit package 300 may correspond to a length L/2 from one end of the plate 430 having the first polarity (e.g., positive polarity) to the electrode cell 410 having the second polarity (e.g., negative polarity). According to this embodiment, since the battery protection circuit package 300 is mounted using only a single side area from the electrode cell 410 having the second polarity (e.g., negative polarity), a small or high-capacity battery may be implemented. For example, by providing another cell or a chip having another function on the other side area from the electrode cell 410, battery capacity may be increased or products having such battery may be reduced in size.

In the above-described battery protection circuit package according to some embodiments of the present invention, compared to a case in which a protection circuit device is mounted on a PCB and then leads are boned onto the PCB, since a protection circuit device may be mounted and leads connected to a battery cell may be provided using only a lead frame, a manufacturing cost may be reduced and a total height may be remarkably reduced. That is, since the PCB generally has a thickness of about 2 mm while the lead frame has a thickness of about 0.8 mm, battery size may be reduced or battery capacity may be increased by a value corresponding to the difference in thickness therebetween.

Furthermore, according to the above-described embodiments of the present invention, if a battery protection circuit package is mounted using only a single side area from an electrode cell of a battery, a small or high-capacity battery may be implemented. However, the battery protection circuit package according to embodiments of the present invention is not limited thereto and may also be configured to use a whole area of a top surface of the electrode cell of the battery.

A substrate of a battery protection circuit package capable of forcibly blocking discharge or charge of a battery bare cell by switching off FETs when an electrical signal is input through a separate terminal according to the technical idea of the present invention is not limited to a substrate including only a lead frame. For example, the substrate for mounting a protection IC, one or more FETs, and one or more passive devices may include a PCB. A variety of additional configurations are also allowed here, and a description is now given of exemplary additional embodiments thereof.

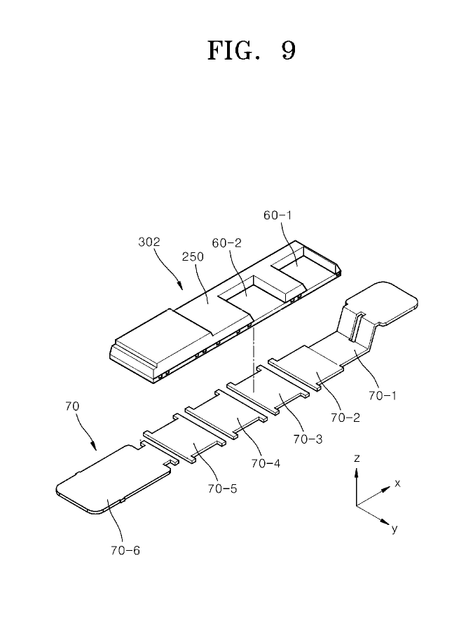

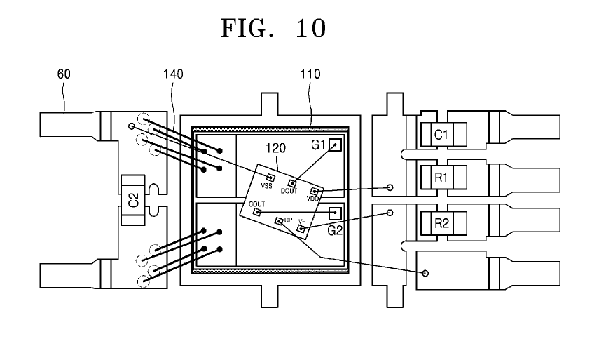

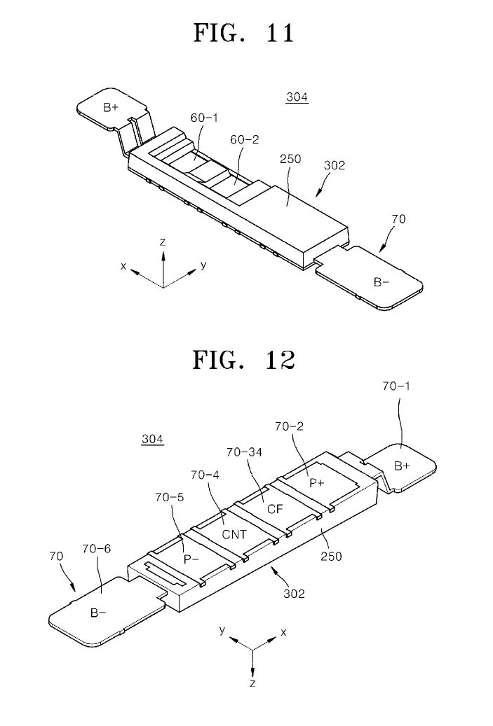

FIG. 9 is an exploded perspective view of a battery protection circuit package 304 according to another embodiment of the present invention, FIG. 10 is an exploded perspective view showing the configuration of a protection IC, FETs, and passive devices in the battery protection circuit package 304 according to another embodiment of the present invention, and FIGS. 11 and 12 are perspective views of the battery protection circuit package 304 according to another embodiment of the present invention.

Referring to FIGS. 9 to 12, the battery protection circuit package 304 according to another embodiment of the present invention includes a terminal lead frame 70 and a device package 302.

The terminal lead frame 70 may include a first internal connection terminal lead 70-1 and a second internal connection terminal lead 70-6 separately provided at two side edges and electrically connected to electrode terminals of a battery bare cell, and external connection terminal leads 70-2, 70-3, 70-4, and 70-5 provided between the first and second internal connection terminal leads 70-1 and 70-6 to configure a plurality of external connection terminals. The external connection terminals may include 4 or more external connection terminals. For example, the external connection terminal leads 70-2, 70-3, 70-4, and 70-5 may correspond to the external connection terminals P+, CF, CNT, and P− illustrated in FIG. 1. The terminal lead frame 70 may be formed of Ni, Cu, Cu plated with Ni, or another metal. Furthermore, surfaces of the external connection terminal leads 70-2, 70-3, 70-4, and 70-5 of the terminal lead frame 70 facing the outside of a battery (e.g., surfaces illustrated in FIG. 8) may be completely or partially plated. A plating material may be at least one selected from the group consisting of gold (Au), silver (Ag), nickel (Ni), tin (Sn), and chromium (Cr).

The device package 302 includes a substrate, a battery protection circuit device mounted on the substrate, and the encapsulant 250 for encapsulating the battery protection circuit device. The battery protection circuit device includes the FETs 110, the protection IC 120, and the passive devices R1, R2, R3, C1, C2, and V1. The encapsulant 250 may include, for example, an epoxy molding compound (EMC). The device package 302 is mounted on the terminal lead frame 70 to be electrically connected to the terminal lead frame 70. For example, the device package 302 may be mounted on the terminal lead frame 70 using a surface mounting technology. One or more conductive lower exposed terminals may be provided on a bottom surface of the device package 302. Furthermore, optionally, one or more upper exposed terminals 60-1 and 60-2 may be provided on a top surface of the device package 302. The encapsulant 250 for encapsulating the battery protection circuit device may expose the lower exposed terminals. Meanwhile, the lower exposed terminals provided on the bottom surface of the device package 302 may be bonded and electrically connected to at least parts of the terminal lead frame 70, thereby configuring at least a part of the battery protection circuit 10 illustrated in FIG. 1.

Referring to FIG. 10, a partial configuration of the device package 302 is illustrated. The device package 302 includes a substrate 60, and the protection IC 120, the FETs 110, and the passive devices R1, R2, C1, and C2 provided on the substrate 60. Furthermore, the electrical connection member 140 for electrically interconnecting any two selected from the group consisting of the protection IC 120, the FETs 110, and the leads may be further employed, thereby implementing the battery protection circuit 10 illustrated in FIG. 1. A detailed description of the protection IC 120 is the same as the description given above in relation to FIGS. 1 and 2.

The device package 302 configures a part of the battery protection circuit package 304 and thus may be understood as a sub package. The substrate of the device package 302 for providing the protection IC 120, the FETs 110, and the passive devices R1, R2, C1, and C2 thereon may include a lead frame, a PCB, a ceramic substrate, or a glass substrate.

To distinguish the substrate of the device package 302 from the terminal lead frame 70 in the battery protection circuit package 304 according to another embodiment of the present invention, the terminal lead frame 70 may be called a first substrate and the substrate of the device package 302 may be called a second substrate.

According to the afore-described embodiments of the present invention, a battery protection circuit package capable of ensuring stability of a battery may be provided. However, the scope of the present invention is not limited to the above-described effect.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A battery protection circuit package capable of being electrically connected to a battery bare cell, the package comprising:
a substrate having a plurality of external connection terminals and a plurality of internal connection terminals; and
a protection integrated chip (IC), one or more field effect transistors (FETs), and one or more passive devices provided on the substrate,
wherein the protection IC comprises a separate IC structure capable of forcibly blocking discharge or charge of the battery bare cell by switching off the FETs when an electrical signal is input through one of the plurality of external connection terminals.

2. The battery protection circuit package of claim 1, wherein the FETs comprise a pair of FETs having a common drain and configured as a first FET and a second FET, and
wherein the protection IC comprises:
a terminal for applying charge and discharge voltages and detecting a battery voltage;
a reference terminal for providing a reference voltage of an internal operation voltage;
a detection terminal for detecting charge/discharge and overcurrent states;
a discharge off signal output terminal for switching off the first FET in overdischarge state;
a charge off signal output terminal for switching off the second FET in overcharge state; and
a forcible blocking terminal configured to receive the electrical signal to forcibly block discharge or charge of the battery bare cell by switching off the FETs.

3. The battery protection circuit package of claim 2, wherein the electrical signal comprises an electrical signal having a high level and a low level, and
wherein the separate IC structure comprises a NOT gate.

4. The battery protection circuit package of claim 1, wherein the protection IC is stacked on the FETs.

5. The battery protection circuit package of claim 1, wherein the protection IC is not stacked on but provided adjacent to the FETs to be spaced apart therefrom.

6. The battery protection circuit package of claim 1, wherein the substrate comprises a lead frame having:
a first internal connection terminal lead and a second internal connection terminal lead separately provided at two side edges and capable of being electrically connected to electrode terminals of the battery bare cell;
external connection terminal leads provided between the first and second internal connection terminal leads to configure the external connection terminals; and
a mounting lead for mounting at least a part of the protection IC, the FETs, and the passive devices.

7. The battery protection circuit package of claim 6, wherein at least one selected from the group consisting of the protection IC and the FETs is not inserted and fixed into the lead frame in a form of a semiconductor package, but is mounted and fixed onto at least a part of a surface of the lead frame using a surface mounting technology in a form of a chip die not encapsulated with an encapsulant.

8. The battery protection circuit package of claim 6, further comprising an electrical connection member for electrically interconnecting any two selected from the group consisting of the protection IC, the FETs, and the leads.

9. The battery protection circuit package of claim 1, wherein the protection IC, the FETs, and the passive devices are embedded in one sub package and then provided on the substrate.

10. The battery protection circuit package of claim 1, wherein the substrate comprises a printed circuit board (PCB).
